(19) United States
(12) Patent Application Publication
(10) Pub. No.: US 2024/0349067 A1
(43) Pub. Date: Oct. 17, 2024

(54) CHANNEL RECOMMENDATIONS FOR NETWORK ELEMENTS IN A SHARED SPECTRUM COMMUNICATION NETWORK

(71) Applicant: Outdoor Wireless Networks LLC, Claremont, NC (US)

(72) Inventors: Navin Srinivasan, Fairfax, VA (US); Ariful Hannan, Sterling, VA (US)

(73) Assignee: Outdoor Wireless Networks LLC, Claremont, NC (US)

(21) Appl. No.: 18/579,821

(22) PCT Filed: Apr. 29, 2022
(86) PCT No.: PCT/US2022/027113

§ 371 Date: Jan. 16, 2024

Related U.S. Application Data
(60) Provisional application No. 63/224,943, filed on Jul. 23, 2021.

(51) Int. Cl. H04W 16/14; H04W 52/24; H04W 72/02; H04W 72/0453

(52) U.S. Cl. CPC H04W 16/14; H04W 52/243; H04W 72/02; H04W 72/0453

(57) ABSTRACT

A method for selecting a channel for a network element in a shared spectrum communication system is provided. The method comprises identifying a plurality of candidate channels of a frequency band of the shared spectrum communication system. For each of the plurality of candidate channels, the method further comprises determining at least one transmit power estimate based on at least one available interference margin. The at least one available interference margin is based on a power allocation protocol for the shared spectrum communication system. The method further comprises scoring each of the plurality of candidate channels based on the at least one transmit power estimate. The method further comprises ranking the plurality of candidate channels based on the scores for each of the plurality of candidate channels. The method further comprises selecting one of the plurality of candidate channels based on the ranking of the plurality of candidate channels.

### CROSS-REFERENCE TO RELATED APPLICATIONS

The present application claims the benefit of U.S. Provisional Patent Application Ser. No. 63/224,943, filed Jul. 23, 2021, titled “CHANNEL RECOMMENDATIONS FOR NETWORK ELEMENTS IN A SHARED SPECTRUM COMMUNICATION NETWORK,” the entire contents of the aforementioned patent application is incorporated herein by reference as if set forth in its entirety.

### BACKGROUND

A shared spectrum communication system enables a network of independent devices desiring to utilize (for example, communicate) over a frequency spectrum covered by the network. Available frequencies are shared by all devices in the network, and access to the frequencies is typically regulated to ensure integrity and predictability in communications in the shared spectrum.

The Citizens Broadband Radio System (CBRS) is but one model for shared spectrum use. The CBRS model operates in the 3.5 GHz band and includes three prioritized levels of access. Tier 1 of the CBRS model is dedicated to incumbents who currently use portions of the frequency band. Tier II of the CBRS model is allocated for Priority Access Licenses (so-called PALs), which allow new or existing users to purchase the exclusive rights to communicate over a block of spectrum in a geographic area, provided there is no interference with Tier I (incumbent) users. Finally, Tier III of the CBRS model is allocated for General Authorized Access (GAA) available to any use provided there is no interference to Tier I or Tier II users. Access across all tiers is managed by a Spectrum Access System (SAS).

The CBRS band includes 150 MHz of total bandwidth and depending on availability, users may consume from 5 MHz up to the entire 150 MHz for a given geographic area. The CBRS band can be conveniently partitioned into “channels” of frequency intervals. For example, the 150 MHz can be represented as thirty 5 MHz channels, fifteen 10 MHz channels, seven 20 MHz channels, or any appropriate combination of 5, 10, and 20 MHz channels. For pedagogical reasons, this disclosure refers to a channel generically, independent of a set bandwidth, unless otherwise stated.

Not all channels in the CBRS band are created equal. Some CBRS channels may be more sensitive, creating interference to, or receiving interference from, users in adjacent bands. Some CBRS channels may be susceptible to a brief use suspension by the SAS due to temporal incumbent activity. Still other CBRS channels may have a higher probability of limited access due to incumbent interference caused by an aggregation of user signals. Some CBRS channels, for sites located in an Exclusion Zone, are prohibited for use altogether.

A multitude of SAS providers could be operating in the shared spectrum communication system, in which each SAS manages a set of CBSDs in a region. As the protection requirements are based on all the CBSDs operating in the region, there must be some coordination between the different operating SASs. This coordination may occur nightly and is known as Coordinated Activities Among SASs, or “CPAS”. CPAS determines the allowable transmit power for the CBSDs to operate in the region. A wireless operator wishing to utilize the CBRS band would ordinarily choose channels that would provide the best desired signal coverage and be less susceptible to suspension or power reductions by the SAS, both at site commissioning and for future use. Common methods for a system operator to choose a channel would be for a Citizens Broadband Radio System Device (CBSD) to query the SAS for available channels and optionally the maximum Effective Isotropic Radiated Power (EIRP) the SAS would allocate to the channel. The CBSD could choose the available channel that meets its EIRP needs. A second method would be for a CBSD to actively scan the radio frequencies associated with channels and measure the received channel power as an indication of channel activity.

Any CBSD wishing to use the CBRS band must send a request (known as a “grant request”) to the SAS. The SAS ensures that the requested channel specified in the grant request meets the governing rules in the shared spectrum access system before approving the request and allowing the requesting CBSD to begin transmitting in the shared spectrum. When a grant request is received from the CBSD it goes through the evaluation process. If the grant request is not affected by any of the governing rules, then the SAS can immediately authorize the CBSD to start using the requested channel.

Communication for lower-tiered CBSDs is often disrupted as a consequence of their lower-priority status in the shared spectrum communication system. For example, any grant request that could potentially impact the incumbent users typically cannot be authorized until the CPAS procedure has been completed. This poses a problem for any CBSDs that need to utilize the shared spectrum to communicate immediately or in short order after submitting a grant request. For example, when a CBSD is installed, the installer would like to test the CBSD immediately to verify that the CBSD is installed correctly rather than returning the next day, after CPAS has been completed, to test the CBSD. Another way CBSD operation could be disrupted is due to the activation of a Dynamic Protection Area (DPA). When a DPA is activated, the CBSDs that are on the move list for the DPA must cease communication for the duration of time that the DPA is activated. This can be problematic for CBSDs due to the asynchronous nature and unpredictability of the activation.

Therefore, a need exists to improve spectrum access continuity for lower-tiered devices in a shared spectrum communication network.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments.

In one embodiment, a method for selecting a channel for a network element in a shared spectrum communication system is provided. The method comprises identifying a plurality of candidate channels of a frequency band of the shared spectrum communication system. For each of the plurality of candidate channels, he method further comprises determining at least one transmit power estimate based on at least one available interference margin. The at least one available interference margin is based on a power allocation protocol for the shared spectrum communication system. The method further comprises scoring each of the plurality of candidate channels based on at least the at least one transmit power estimate. The method further comprises ranking the plurality of candidate channels based on the scores for each of the plurality of candidate channels. The method further comprises selecting one of the plurality of candidate channels based on the ranking of the plurality of candidate channels.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an exemplary shared spectrum communication system including a channel evaluator disposed in a spectrum access system, according to the teachings of the present invention;

FIG. 2 is a block diagram of an exemplary shared spectrum communication system including a plurality of spectrum access systems in communication with each other, according to the teachings of the present invention;

FIG. 3 is a block diagram of an exemplary channel evaluator configured to select a candidate channel for use by a network element from a plurality of candidate channels, according to the teachings of the present invention;

FIG. 4 is a block diagram of an exemplary channel recommendation function configured to select a candidate channel based on recommended operation parameters and information from the shared spectrum communication system, according to the teachings of the present invention;

FIG. 5 is a flow diagram of an exemplary method of evaluating a channel in a list of candidate channels, according to the teachings of the present invention;

FIG. 6 is a flow diagram of an exemplary method of selecting at least one channel in response to a request by a network element for access to a shared spectrum communication system, according to the teachings of the present invention;

FIG. 7 is a message sequence diagram depicting communication between a CBSD and SAS when a CBSD sends a grant request to the SAS for a channel on the shared spectrum communication system, according to the teachings of the present invention;

FIG. 8 is a flow diagram of an exemplary method of selecting at least one channel in response to a notice of a Dynamic Protection Area (DPA) activation for an incumbent device in a shared spectrum communications network, according to the teachings of the present invention;

FIG. 9 is a message sequence diagram depicting communication between a CBSD and SAS when a DPA is activated in the shared spectrum communication system, according to the teachings of the present invention;

FIGS. 10A-10B are block diagrams of classifying a frequency band into channels for selection in a shared spectrum communication system, according to the teachings of the present invention;

FIG. 11 is a block diagram of an exemplary automated frequency coordination (AFC) network, according to the teachings of the present invention;

FIG. 12 is a flow diagram of an exemplary method for sending a channel evaluation including one or more parameters of an incumbent-free channel, according to the teachings of the present invention; and

FIG. 13 is a flow diagram of an exemplary method for determining one or more parameters of candidate channels of a frequency band, according to the teachings of the present invention.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The embodiments described in this disclosure present improvements to shared spectrum access for network elements utilizing a shared spectrum communication system, of which one example is a CBSD communicating or attempting to access a channel in the CBRS. In particular, the techniques described herein improve spectrum access continuity for lower-tiered network elements by providing adaptive channel recommendations in response to potential, actual, or anticipated changes in the shared spectrum communication network from higher-tiered network elements that may result in disruptive communication for lower-tiered network elements. When intended communication parameters cannot be granted to a CBSD (for example, by a request that detrimentally impacts an incumbent or the activation of a DPA), a channel recommendation can be provided to the affected CBSD in real-time that provides an alternative channel recommendation the CBSD can use without violating the protection parameters given to incumbent users in the network.

When triggered, the channel recommendation function assesses potential candidate channels in a given frequency band and evaluates the channels to find a suitable alternative channel recommendation for the network element. As part of the channel evaluation process, at least one transmit power estimate for the network element can be determined that corresponds to each channel. The candidate channels are then ranked, and a channel is selected from the potential candidate channels based on the ranking, along with one or more operating parameters required for the network element to communicate over the recommended channel.

Different embodiments of the disclosure add unique constraints to accommodate the dynamics of the shared spectrum communication system. For example, the at least one transmit power estimate can be constrained by a power change metric to ensure that a recommended channel does not adversely impact other devices in the communication system communicating at or near the recommended channel.

Embodiments of the present invention will now be described in further detail below with reference to the accompanying figures.

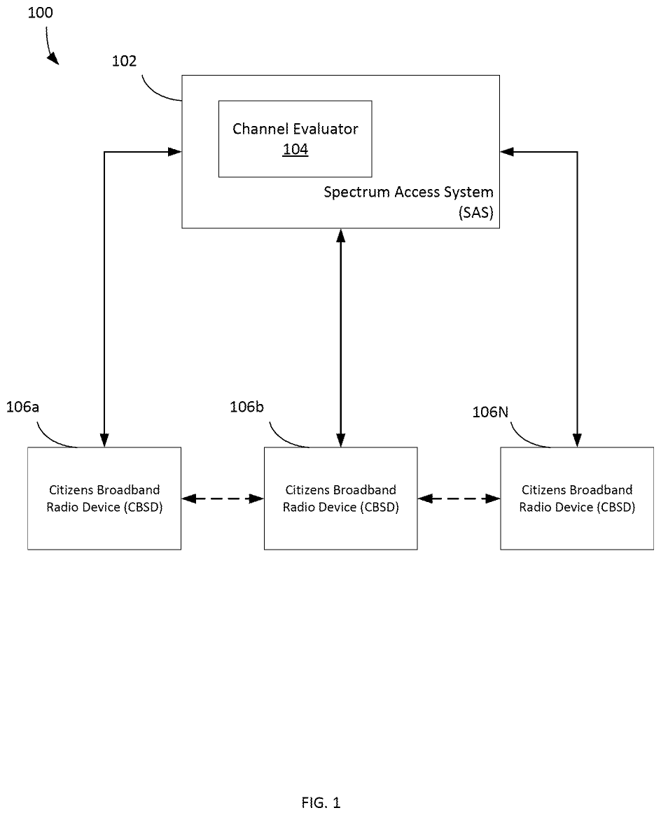

FIG. 1 is a block diagram of an exemplary shared spectrum communication system (system). The shared spectrum communication system is indicated generally at 100, though in one embodiment shared spectrum communication system is a CBRS network as described above. System 100 includes a spectrum access system (SAS) 102 in communication with at least one Citizens Broadband Radio Device (CBSD) 106. While three such devices are explicitly shown in FIG. 1 (CBSD 106a, CBSD 106b, CBSD 106N), system 100 can include any N number of CBSDs (N can be a number less than three as well). Each CBSD 106a-N is configured to communicate over frequencies provided by the shared spectrum communication system.

SAS 102 manages access to frequency bands in the shared spectrum communication network. When a CBSD (say, CBSD 106a for example) desires to communicate over frequencies in the frequency bands managed by the SAS 102, the CBSD sends a request to SAS 102 for approval to access one or more channels in the network. Sometimes the CBSD may know a priori which frequencies it wishes to access (for example, by scanning available channels). Accordingly, in some embodiments the request includes specified parameters such as the frequencies and the transmit power the CBSD intends to use in communicating over the requested channel. The request may include other information as well, such as measurement reports from the CBSD or grouping information. This information can be used for coexistence with other CBSDs in the shared spectrum communication system 100 and/or for the channel allocation and recommendation processes described below. In a CBRS system, each CBSD 106a-N may need to register with the SAS 102 before the respective CBSD can send a valid request for spectrum access.

The SAS 102 can be implemented as software or firmware on a hosted network. Each CBSD 106a-N can be implemented as a standard device according to known industry standards (e.g., as a category A device, category B device, end user device, or other device). In some embodiments, each CBSD 106a-N includes an antenna and circuitry that is configured to convert frequency signals received by the antenna (for example, signals sent by SAS 102) into electrical signals and process the electrical signals into information/data that is communicated to the device user. Each CBSD 106a-N is optionally configured to communicate with other CBSDs in the shared spectrum communication system 100. By way of example, CBSD 106a can communicate with CBSD 106b and vise-versa, as well as any other CBSD 106N in system 100 (not explicitly shown in FIG. 1).

Advantageously, SAS 102 includes functionality that enables CBSDs to begin or continue transmission in situations that would traditionally create disruptions in service by the CBSDs. Specifically, SAS 102 further includes channel evaluator 104 that is configured to evaluate channels in the shared spectrum communication system 100 so that a CBSD that would otherwise experience a service disruption is able to begin or continue provide service. When conditions trigger the need to evaluate channels for a CBSD in the shared spectrum communication system, channel evaluator 104 can identify a plurality of candidate channels and evaluate each potential candidate channel based on at least the allowable transmit power for the CBSD to operate in communicating over the candidate channel. Evaluating each candidate channel can include determining at least one transmit power estimate for the channel, scoring each channel, and ranking each channel based on the assigned scores. Once channel evaluator 104 has evaluated each candidate channel, it provides a channel recommendation based on the ranking of channels to the affected CBSDs, that, when accepted, enables the CBSDs to communicate over the recommended channel. As part of the recommendation process, channel evaluator 104 can also provide at least one operating parameter, such as a transmit power that the CBSD must follow should the CBSD accept the channel recommendation.

There are various situations where incumbent activity, or potential incumbent activity, can disrupt operation of a CBSD. For example, when a grant request is received from a CBSD, the CBSD would normally be required to wait until after the next CPAS window to receive authorization to transmit thereby disrupting communication by the CBSD. To address this problem, channel evaluator 104 is configured to evaluate channels in the shared spectrum and provide a channel recommendation once SAS 102 receives a grant request for spectrum access by one of CBSD 106a-N outside of the CPAS window when operation on the requested channel would be impacted by an incumbent protection requirement. Additionally, CBSD operation is impacted by the activation of a dynamic protection area (DPA), when an incumbent begins to use a channel used by a lower priority CBSD. Similarly, in this situation, channel evaluator 104 is configured to evaluate channels and provide a channel recommendation when SAS 102 receives notice of a DPA activation that requires spectrum access suspension of one or more of CBSDs 106a-N thereby giving the CBSD the opportunity to continue operation but on a different channel.

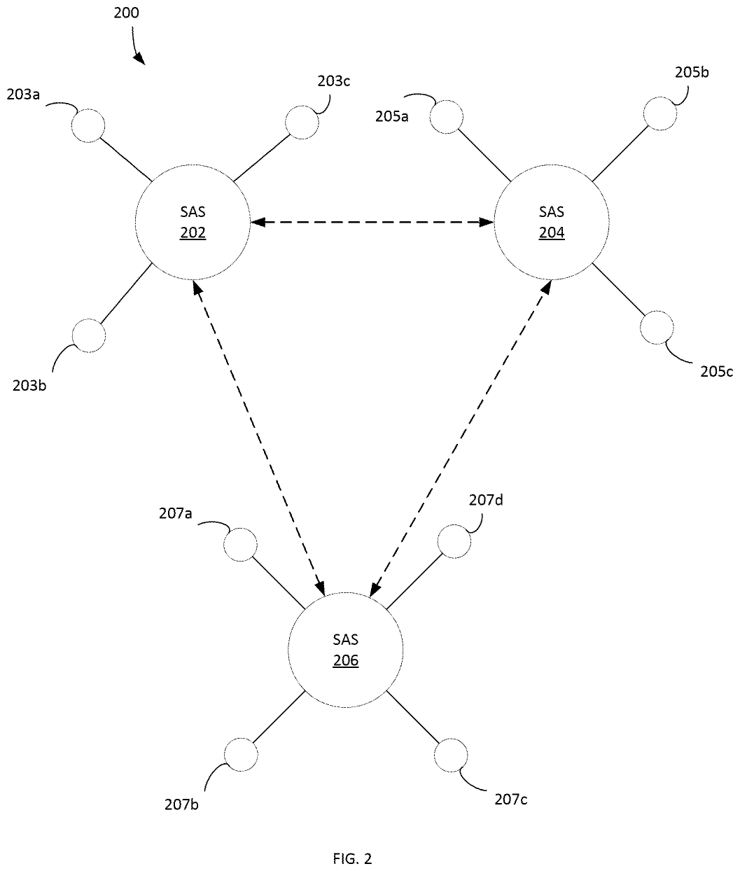

FIG. 2 is a block diagram of an exemplary shared spectrum communication system that includes multiple SAS in communication with each other. System 200 explicitly illustrates three such SAS (SAS 202, SAS 204, SAS 206) by way of example, although more or fewer SAS can be implemented. Since multiple SAS manage access to the same shared spectrum in a region, each respective SAS may communicate with an arbitrary number of network elements. The term “network element” as used in this disclosure refers to a device in the shared spectrum communication system that communicates over frequencies in the shared spectrum communication system. One example of a network element is a CBSD. Thus, in one embodiment, the network elements corresponding to an SAS in system 200 (network elements 203a-c, for example) are equivalent to CBSD 106a-N, respectively.

As shown in FIG. 2, SAS 202 is communicatively coupled to network elements 203a-c; SAS 204 is communicatively coupled to network elements 205a-c; and SAS 206 is communicatively coupled to network elements 207a-c. In some embodiments, SAS 202, SAS 204, and SAS 206 are configured to coordinate among each other to determine an aggregated allowable transmit power level for all network elements that correspond to each respective SAS for the next operating cycle. In the CBRS model, this coordination can occur nightly between all SAS providers in a region, which is known as Coordinated Periodic Activities among SAS or “CPAS”. For example, SAS 202 can coordinate with SAS 204 and SAS 206 to determine the maximum allowable transmit power level that all network elements 203a-c may operate when utilizing the shared spectrum. CPAS is pedagogically described as a nightly operation in this disclosure; however, CPAS may occur during other time periods as well in a shared spectrum communication system.

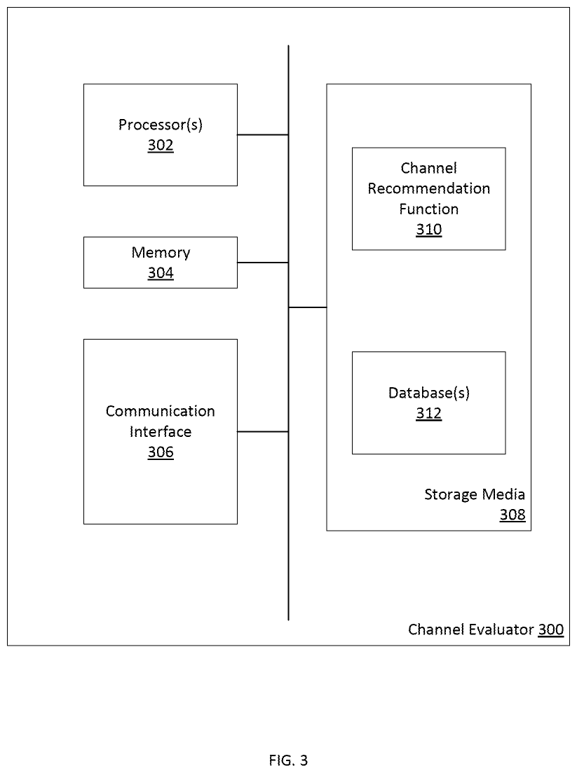

Each SAS 202, 204, and 206 can include a channel evaluator such as channel evaluator 104 described in FIG. 1 or further described in FIG. 3 to evaluate channels and provide a channel recommendation for a network element communicatively coupled to the respective SAS. As an example, network element 203a can request access to the shared spectrum by sending a grant request to SAS 202. If the grant request adversely impacts one or more incumbent users in the shared spectrum communication system, SAS 202 can implement a channel evaluator to identify candidate channels in the shared spectrum and evaluate each channel based on at least the allowable transmit power for the network element to operate in communicating over the candidate channel. Other conditions, such as the activation of a DPA, can also trigger SAS 202 to evaluate candidate channels and provide a recommendation for a network element that is already authorized to communicate in the shared spectrum but becomes suspended due to the scope of the DPA.

FIG. 3 is a block diagram of an exemplary channel evaluator configured to select a candidate channel for use by a network element from a plurality of candidate channels. Channel evaluator 300 can be implemented in a SAS to evaluate a grant request from a network element and recommend alternative channels when the parameters of a received or previously approved grant are unsuitable for spectrum access.

Channel evaluator 300 includes at least one processor 302 that is operable to read and execute instructions to perform functions in the SAS, such as channel recommendation function 310. Processor 302 may include any one or combination of processors, microprocessors, digital signal processors (DSP), application specific integrated circuits (ASIC), field programmable gate arrays (FPGA), and/or other similar variants thereof. Processor 302 may also include, or function with, software programs, firmware, or other computer readable instructions for carrying out various process tasks, calculations, and control functions. In one embodiment, the instructions are stored or otherwise embodied on or in an appropriate non-transitory storage medium or media 308. Storage media 308 can include flash memory or other non-volatile memory, magnetic disc drives and/or optical disc drives as channel recommendation function 310. When executed by processor 302, channel recommendation function 310 evaluates and determines an alternative channel, transmit power, frequency, and/or bandwidth for a network element impacted by a change in spectrum access in the shared spectrum communication system, or when new network element requests access to the shared spectrum that does not comply with the governing standards of the shared spectrum communication system. Instead of forbidding spectrum access entirely for the requesting network element, channel recommendation function 310 can recommend a channel that both complies with the governing standards of the shared spectrum communication system and in some embodiments, accommodate the preferences of the requesting network element.

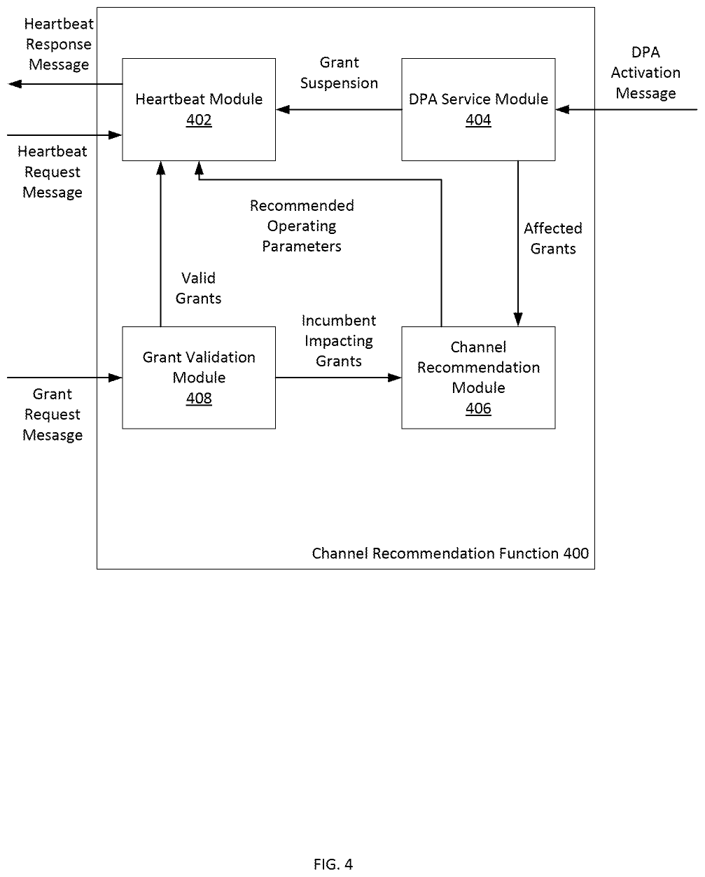

When triggered, channel recommendation function 310 evaluates channels by identifying a plurality of candidate channels in the shared spectrum. Channel recommendation function 310 continues the channel evaluation process by evaluating each candidate channel based on at least the allowable transmit power over that channel. Each candidate channel is then assigned a score and the channels are ranked based on the assigned scores. Channel recommendation function 310 can then select a candidate channel based on the channel ranking and send the channel recommendation to a network element. Various embodiments for recommending an alternative channel are described in detail with respect to FIGS. 4-9 below.

Channel evaluator 300 includes memory 304 for storing the program instructions of channel recommendation function 310, as well as any related data during execution by processor 302. Memory 304 comprises, in one embodiment, any suitable form of random-access memory (RAM) now known or later developed, such as dynamic random access memory (DRAM). In other embodiments, other types of memory are used. Some examples include conventional hard disks, Compact Disk-Read Only Memory (CD-ROM), volatile media, non-volatile media such as Synchronous Dynamic Random Access Memory (SDRAM), Double Data Rate (DDR) RAM, RAMBUS Dynamic RAM (RDRAM), Static RAM (SRAM), etc.), Read Only Memory (ROM), and Electrically Erasable Programmable ROM (EEPROM). The data generated from SAS operation function may be stored in databases 312 stored on storage media 308 or may be retrieved from another entity over communication interface 306. Other data may also be stored in databases 312. For example, previous grant requests received from network elements can be stored in databases 312 for future reference by the SAS, which may in some embodiments be used to score candidate channels based on preferences and other information detailed in the grant request.

FIG. 4 is a block diagram of an exemplary channel recommendation function used to determine alternative channel recommendations and communicate recommendations to network elements. Channel recommendation function 400 can be implemented as software or firmware executed by a processor or other programmable logic device, such as processor 302 of FIG. 3. Accordingly, channel recommendation function 400 illustrates an exemplary embodiment of channel recommendation function 310.

Channel recommendation function 400 includes a heartbeat module 402, which is used to communicate messages to network elements coupled to the SAS, in addition to receiving messages from network elements. When the SAS examines a grant request, or when some condition requires suspension of a previously approved grant request, heartbeat module 402 transmits a message to the impacted network elements informing them of the status of the grant. Additionally, heartbeat module 402 transmits channel recommendations to the affected network elements when conditions in the shared spectrum communication system trigger a channel recommendation, for example, in response to a grant request from a network element that impacts an incumbent user, or the activation of a DPA.

Grant requests sent by network elements desiring to communicate over a frequency in the shared spectrum are received by a grant validation module 408. Grant validation module 408 is configured to determine whether the parameters outlined in the grant request comply with the governing rules in the shared spectrum communication system. In the CBRS model, grant requests are evaluated under a governing set of rules known as the Part 96 Rules, which, as described above, implement a priority scheme that prioritizes incumbent users utilizing frequencies covered by the CBRS band. For grant requests that are deemed to be acceptable under the governing standards, grant validation module 408 grants the request and notifies heartbeat module 402 of the valid request. Heartbeat module 402 can then send a message on the heartbeat protocol informing the network element that its request has been approved.

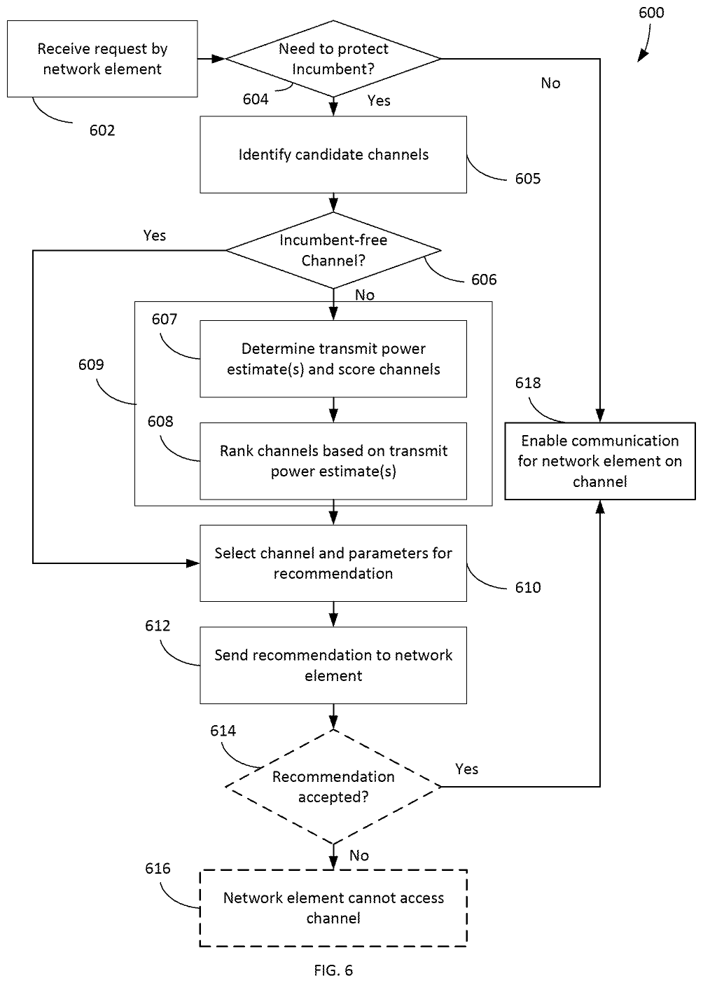

Not all grant requests meet the same fate. If grant validation module 408 determines that a grant request will adversely impact one or more incumbent users (or other higher-tiered network elements) utilizing the shared spectrum (see FIG. 6), grant validation module 408 is configured to send a message to channel recommendation module 406 to attempt to find a channel that can accommodate the request. Channel recommendation module 406 evaluates the request in view of other potential candidate channels in the spectrum to determine a suitable alternative channel to recommend to the requesting network element. When channel recommendation module 406 determines a suitable channel, it sends a message to heartbeat module 402 with the channel recommendation and the operating parameters for communicating over the channel. In some embodiments, operating parameters include at least one transmit power level that the network element must satisfy to utilize the recommended channel. Heartbeat module 402 then sends a message to the network element with the recommendation.

Sometimes a grant request previously approved by grant validation module 408 can, at a later time, be suspended due to a status change of one or more higher-tiered network elements in the shared spectrum communication system. One example is when a higher-tiered network element (e.g., an incumbent user) activates a DPA in a geographic area that covers frequencies utilized by lower-tiered network elements. In the CBRS model, the activation of a DPA can render a once acceptable grant request unacceptable because the overlapping frequencies used by the lower-tiered network element impact the protection given to the higher-tiered network element. DPA activations may not be foreseeable for the lower-tiered network elements or the SAS in some instances.

When a DPA is activated, the SAS is configured to suspend any approved grants that do not comply with the terms of the DPA. In one embodiment, the SAS becomes notified of a DPA activation through a message that is received by DPA service module 404. DPA service module 404 is then configured to assess the scope of the DPA and analyze how the DPA activation impacts the grants approved by the SAS. For any grants that do not comply with the DPA activation, DPA service module 404 sends a message to heartbeat module 402 of which grants should be suspended. DPA service module 404 also sends a message to channel recommendation module 406 to determine a suitable alternative channel (including operational parameters) to send to the affected network element(s).

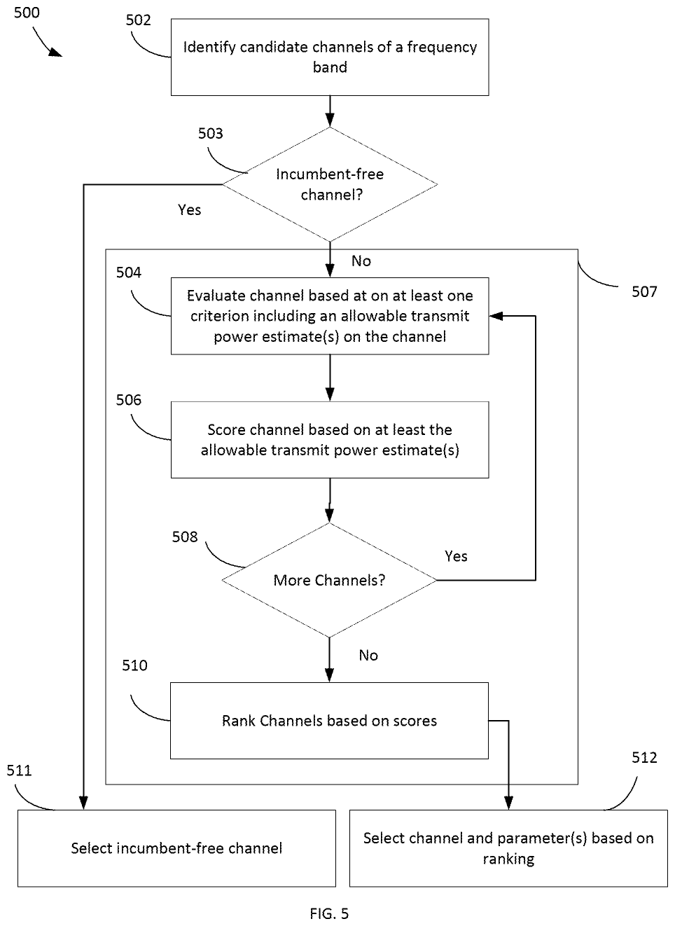

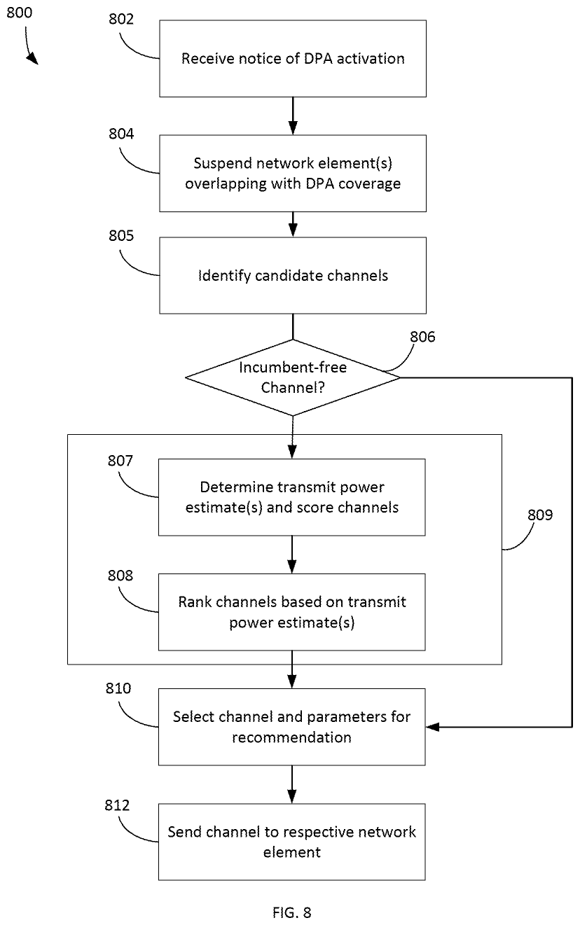

FIG. 5 is a flow diagram of an exemplary method 500 of evaluating a channel in a frequency band of a shared spectrum communication network. Method 500 and other methods described herein (see FIGS. 6 and 8) may be implemented via the techniques described with respect to FIGS. 1-4, but may be implemented via other techniques as well. The blocks of the flow diagram have been arranged in a generally sequential manner for ease of explanation.

Beginning at block 502, method 500 identifies one or more candidate channels of a frequency band in the shared spectrum communication system. In some embodiments, channels are identified based on the governing standards in the shared spectrum communication system. For example, channels are identified that do not sufficiently impact one or more higher-tiered devices protected in the shared spectrum communication system, such as an incumbent user. This may account for current or future DPA activations, if such future activations are known. In another example, channels are identified that do not overlap with frequencies covered by exclusion zones in the neighborhood of the network element.

The identified frequency band can then be partitioned into candidate channels. Each channel in the frequency band comprises a frequency range (otherwise referred to as a bandwidth). In some embodiments, the bandwidth of the candidate channels can be determined based on the parameters of the grant requested or approved by the network element. For example, if a network element requests a bandwidth of 20 MHz in the shared spectrum, the SAS can partition each of the candidate channels having a bandwidth of 20 MHz. In other embodiments, the bandwidth of each channel is determined based on an equitable share of the spectrum with other network elements utilizing nearby frequencies. Equitable sharing can reduce or minimize the interference between nearby network elements should a channel recommendation be accepted.

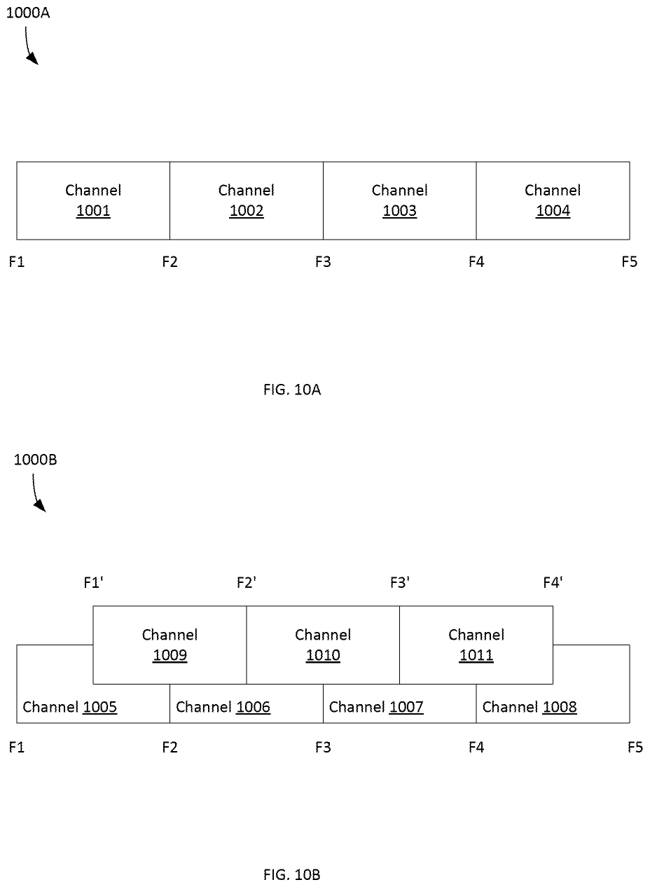

Referring to FIG. 10A, an exemplary frequency band 1000A is depicted that is partitioned into multiple candidate channels as a result of, for example, block 502 of method 500 above. As shown in FIG. 10A, the frequency band is partitioned into four channels: channel 1001, channel 1002, channel 1003, channel 1004. The bandwidth of each channel is determined by the frequency difference between the frequencies at the end points of the respective channel. For example, the bandwidth of channel 1001 is (F2−F1). While in some embodiments each channel can have an equal bandwidth, in other embodiments the bandwidths for each of the candidate channels may be different. FIG. 10A illustrates an embodiment where each channel of frequency band 1000A is non-overlapping with respect to another candidate channel.

This may not always be the case. In some embodiments, such as shown in FIG. 10B, the identified channels may overlap in frequency with other identified channels. Consider, for example, channel 1009 in frequency band 1000B. The bandwidth of channel 1009 is determined by the frequency difference between frequency F2′ and F1′, or (F2′−F1′). However, frequency F1′ is also included within the frequency range of channel 1005 and frequency F2′ is likewise included in the frequency range of channel 1006. Thus, channel 1009 is overlapping with respect to channel 1005 and channel 1006.

Accordingly, in some embodiments, channel 1009, channel 1010, and channel 1011 comprise a second set of identified candidate channels that can be evaluated after the first set of channels comprising channel 1005, channel 1006, channel 1007, and channel 1008 have been evaluated. Such embodiments may be desirable for the SAS to better accommodate requests from a network element that prioritize a particular frequency range.

Referring back to FIG. 5, at block 503 method 500 determines whether each channel impacts one or more incumbent users in the frequency band. A candidate channel is classified as an “incumbent-free channel” if the channel is located in a frequency band within the neighborhood of one or more incumbent users but the frequencies of the channel do not overlap with an operating frequency of an incumbent device. Conversely, a candidate channel is classified as an “incumbent-impacting channel” if the candidate channel is located in a frequency band within the neighborhood of one or more incumbent users and at least one frequency of the channel overlaps with an operating frequency of an incumbent users. If method 500 determines that a designated channel is incumbent-free, then method 500 proceeds to block 511 to select an incumbent-free channel from the candidate channels. If more than one incumbent-free channel is in the frequency band, an incumbent-free channel can be selected at random. An incumbent-free channel will have no restrictions on transmit power. Therefore, selecting an incumbent-free channel enables the network element to operate at its full operational power on the channel or the transmit power requested by the network element in the request. If method 500 determines that a candidate channel is incumbent-impacting, then the transmit power level for that channel is determined based on an allowable threshold that conforms to the protection given to the incumbent user, as described further below.

If there are no incumbent-free channels available, method 500 proceeds from block 503 to block 507 to rank each identified channel in the frequency band. In one embodiment of block 507, the identified channels are ranked as follows. At block 504, method 500 evaluates a designated channel based on at least one criterion including at least one allowable transmit power estimate on the channel. In some embodiments, the SAS evaluates the candidate channel based on whether the allowable transmit power estimate would be sufficient for the operation parameters of the requesting network device. Additionally, or alternatively, the SAS evaluates the candidate channel based on whether the requested transmit power would impact one or more incumbent users in the network (see FIG. 6). In yet further embodiments, the SAS evaluates the candidate channel based on a plurality of criteria that includes evaluating the transmit power estimate on the channel in addition to additional criteria relevant to the shared spectrum communication system.

Once the designated candidate channel is evaluated, method 500 proceeds to block 506 by scoring the candidate channel based on at least the allowable transmit power level estimate. As described further below, in some embodiments the SAS scores the candidate channel based on a weighting factor associated with the allowable transmit power level estimate. The SAS can also score the channel based on input parameters from the network element. For example, the SAS can score the channel based on the parameters specified in the grant request for a network element. Alternatively, when a DPA has been activated the SAS can access a stored grant request for an affected network element utilizing the shared spectrum to determine which channels would be preferred for the affected network element.

Proceeding to block 508, method 500 determines whether there are additional channels that were identified in the frequency band. If yes, then method 500 reverts back to blocks 504 and 506 to repeat the channel evaluation and scoring process for each remaining channel. If every channel in the frequency band has been evaluated and scored, then method 500 proceeds to block 510 to rank the channels based on the assigned scores.

At block 512, method 500 selects a channel and one or more operating parameters based on the ranking performed in block 510. In some embodiments, method 500 selects the channel with the highest overall score. If the highest score is shared by a plurality of channels, then method 500 selects one of those channels at random. In other embodiments, method 500 selects a designated number of channels that meet a score threshold to recommend to the network element.

FIG. 6 is a flow diagram of an exemplary method of selecting at least one alternate channel in response to a request by a network element for access to a shared spectrum communication system. FIG. 6 can in some embodiments be performed using the techniques described in method 500.

Beginning at block 602, method 600 receives a grant request from a network element such as a CBSD. At block 604, method 600 determines whether the grant request is from a network element that is in the neighborhood of an incumbent user. If method 600 determines that the grant request from the network element is not in the neighborhood of an incumbent, then method 600 concludes that the request will not violate any protection rules in the shared spectrum communication system afforded to incumbent users. Accordingly, method 600 proceeds to block 618 to grant the request and enable spectrum access to the network element so that the network element can communicate over the channel according to the parameters of the request.

If method 600 determines that the grant request is in the neighborhood of one or more incumbent users, method 600 proceeds to block 605. At block 605 method 600 identifies candidate channels in the frequency band using, for example, the techniques described in FIGS. 5 and/or FIGS. 10A-10B. At block 606, method 600 determines whether there are any incumbent-free channels in the frequency and if so, method 600 proceeds directly to block 610 to select one of the incumbent-free channels from the list of candidate channels. For incumbent-free channels, there is no restriction in transmit power and so the network element can operate at full operational transmit power for the recommended channel. If there are no incumbent-free channels available, then method 600 proceeds to block 609 to begin the channel evaluation process for each incumbent-impacting channel.

For each candidate channel, method 600 determines at block 607 at least one transmit power estimate based on at least one available interference margin. Each interference margin can correspond to a distinct power allocation protocol for the shared spectrum communication system. One example of a power allocation protocol is the CPAS protocol, in which a SAS in the shared spectrum communication system exchanges information with other SAS in the shared spectrum communication system to determine the appropriate interference margin for the next shared spectrum cycle. Another example of a power allocation protocol is one in which the SAS does not coordinate among other SASs. As described below, the SAS can utilize a standard industry defined interference margin or interference margin generated as a result of the transmit power allocation using the Iterative Allocation Process (IAP). The standard industry defined interference margin and/or a margin resulting due to the IAP can be used to set as the available interference margin for enabling daytime (defined below) communication in the shared spectrum communication system, since CPAS can often occur during nighttime hours.

Method 600 determines at least one transmit power estimate as part of the channel recommendation process. In some embodiments, the transmit power estimate includes a first and second transmit power estimate for each of the candidate channels at block 607. The first and second transmit power estimates correspond to an estimate of an operational transmit power by the requesting network element for communicating over the respective candidate channel, and are each determined by distinct power allocation protocols on the candidate channel. For example, the first transmit power estimate can correspond to the daytime transmit power that the network element can transmit in a geographic region. The term “daytime transmit power” refers to a transmit power estimate calculated outside of a Coordinated Activities Among SASs (CPAS) window, which typically (but not exclusively) occurs during daytime hours. Thus, a “daytime transmit power” can correspond to any period of use that is outside of a CPAS window, including any evening or morning hours outside of CPAS. The second transmit power estimate can correspond to the CPAS transmit power that the network element can use for operation until the next CPAS window. As described above, CPAS is typically a nightly operation.

In some embodiments, the SAS initially determines whether each of the candidate channels are incumbent-free or incumbent-impacting channels, and transmit power estimation is performed for incumbent-impacting channels, as described with respect to FIG. 5.

To determine the first transmit power estimate, the SAS may compute a daytime transmit power estimate based on the daytime interference margin for the channel. In one embodiment, the SAS uses the IAP process to determine the daytime transmit power estimate. The IAP process is run for all the CBSDs that have been allocated an operational transmit using the daytime margin, in the frequency band. In general, an interference margin is a threshold interference signal level that the lower-tiered network elements cannot exceed and is determined based on the power allocation protocol. An interference margin can also consider the aggregate interference for all network elements in the frequency band, in which case the daytime transmit power estimate is determined based on the aggregate interference of all network elements as compared to the daytime interference margin allowed for the frequency band (e.g., the maximum amount of interference that can be added in the frequency band, outside of CPAS, so that the overall aggregate interference from all network elements is still within the protection threshold of an incumbent user). In some embodiments, the daytime interference margin is determined based on a pre-allocated margin threshold (known by the Wireless Innovation Forum (WINNF) standard as the Headroom Margin). Alternatively, the daytime interference margin is determined based on IAP at a protection point (known as a post-IAP or PIAP margin).

For example, in one embodiment the daytime Headroom Margin available for distribution at a protection point p is determined by the following equation:

$${HM}_{p} = \frac{{10}^{\frac{{Q}_{p}}{10}} - {10}^{\frac{{Q}_{p} - {M}_{p}}{10}}}{{N}_{SAS}} mW / IAP\_BW$$

where HMₚ is the Headroom Margin available for distribution, Qₚ is the protection threshold for the protection point p at a reference bandwidth, Mₚ is the Headroom Margin for the protection point, N_{SAS} is the number of operating SAS, and IAP_BW is the reference bandwidth. In another embodiment, the daytime PIAP interference margin for a protection point p can be determined based on the sum of a common leftover component and a CBSD attributed unused component, in which the common leftover component is defined as:

$$\frac{{10}^{\frac{{Q}_{p}}{10}} - {10}^{\frac{{Q}_{p} - {A}_{p}}{10}}}{{N}_{SAS}} mW / IAP\_BW$$

and the CBSD attributed unused component is:

$${10}^{\frac{{ASAS}_{p}^{S}}{10}} - {10}^{\frac{{Aaggr}_{p}^{S}}{10}} mW / IAP\_BW$$

Aₚ is the aggregate interference calculated by the managing SAS using the EIRP obtained by all CBSDs (including the CBSDs managed by other SASs) through the application of IAP for protected point p. ASASₚ^{S} is the aggregate interference calculated by the managing SAS using the EIRP obtained by all CBSDs managed by the managing SAS through application of IAP for protected entity p. Finally, Aaggrₚ^{S} is the aggregate interference calculated by the managing SAS using the minimum of EIRPs from IAP applied over all protected entities that a CBSD impacts. In some embodiments, a combination of the Headroom Margin and the PIAP margin is used to determine the daytime transmit power estimate.

In some embodiments, the SAS can additionally constrain the first transmit power estimate by calculating an Authorized CBSD Power Change metric along with the daytime transmit power estimate. The Authorized CBSD Power Change metric for a given channel is defined as the percentage of authorized CBSDs that are part of the IAP process for the candidate channel whose allowable transmit power has changed, and is below a minimum operational power threshold based on the CBSD category. When the SAS determines an Authorized CBSD Power Change metric, a channel can be considered a potential candidate for recommendation if the allowable transmit power is above an operational transmit power threshold and the Authorized CBSD Power Change metric is less than a power change threshold. The power change metric threshold can be termed as the Percentage Power Change Threshold. For example, if the authorized CBSD power change threshold for a channel corresponds to 0%, then none of the CBSDs in the vicinity of the channel need to change their operational power. If the Authorized CBSD Power Change metric is above the power change threshold, then in some embodiments the candidate channel is given a reduced score or disqualified as a candidate channel because it can adversely impact other network elements operating in the shared spectrum if the requesting network element were granted to operate on the candidate channel.

The daytime transmit power estimate computed based on the daytime interference margin, in one embodiment can be constrained as follows:

$${TxPow}_{Day \_ ch \_ i} = \{ \begin{matrix}{TxPow}_{Day - {ch}_{i}} & if Condition 1 is satisfied \\ n & otherwise\end{matrix} \}$$

where Condition1 is defined as:

Authorized CBSD Power Change Metric_{ch_i}≤Percentage Power Change Threshold

and

TxPow_{Day-chi}>Operational Transmit Power Threshold1

To describe more qualitatively, the daytime transmit power estimate corresponding to the ith candidate channel is the daytime transmit power estimate calculated above if the Authorized CBSD Power Change Metric corresponding to the ith channel is less than or equal to the Percentage Power Change Threshold (Condition 1) and the daytime transmit power estimate is greater than the operational transmit power threshold. If Condition 1 is not satisfied, however, then the daytime transmit power estimate is designated as n, which is a value less than the initial first transmit power estimate TxPow_{Day-ch}_{ᵢ}. In some embodiments, n=0 or other small value in which case the channel is not chosen due to the stringent restrictions on transmit power for the candidate channel. However, the constraint can be modified in other ways, such as by modifying the daytime transmit power estimate value if Condition 1 is not satisfied (by setting a value other than 0, for example, or by otherwise reducing the daytime transmit power estimate).

To determine the second power transmit estimate, the SAS may compute a CPAS transmit power estimate based on the CPAS interference margin. The CPAS transmit power estimate corresponds to the transmit power the network element may be allocated according to the power allocation technique (IAP) that occurs as part of the nightly CPAS operation. The CPAS transmit power estimate is determined using the IAP technique. The IAP process is run over all the CBSDs in the frequency band. In one embodiment, the CPAS transmit power estimate determined can be constrained as follows:

$${TxPow}_{CPAS \_ ch \_ i} = \{ \begin{matrix}{TxPow}_{CPAS - {ch}_{i}} & if Condition 2 is satisfied \\ n & otherwise\end{matrix} \}$$

where Condition2 is defined as:

TxPOW_{CPAS-chi}>Operational Transmit Power Threshold2.

Once the transmit power estimates for each channel are determined, the SAS then generates a score for each of the channels based on the transmit power estimates. For example, for each candidate channel in the frequency band (or alternatively each incumbent-impacting channel in the frequency band), the SAS can compute a recommendation score based on the first and second transmit power estimates for the candidate channel. In some embodiments, the recommendation score can be weighted based on input provided by the network element. Thus, in one embodiment a recommendation score for an ith channel in a channel list can be calculated with the formula:

$${recomScore}_{ch \_ i} = {W}_{1} \times {TxPow}_{Day \_ ch \_ i} + {W}_{2} \times {TxPow}_{CPAS \_ ch \_ i}$$

where W₁ and W₂ are weighting factors.

As shown directly above, method 600 can optionally score each channel by weighting the first and second transmit power estimates (in some embodiments, the weighting factors are simply 1). For example, the scores can be weighted based on when the network element intends to use the channel as indicated by the network element over the communication channel between the network element and the SAS or as a configuration setting on the SAS for the network element. If the network element intends to communicate during the scope covered by the first transmit power estimate but not during the scope covered by the second transmit power estimate, the scores can be weighted to prioritize a channel more suitable for communication during the first transmit power estimate. The scores can also be weighted based on whether the network element requires immediate communication once the network element can access the shared spectrum, or whether the network element prefers a stable channel for long-term but not necessarily immediate communication. In such cases, weighting factors W₁ and W₂ can be adjusted to tailor the channel recommendation to be more suitable for the network element.

For example, consider a situation where a network element desires a channel that is available for use during the daytime that can be authorized immediately for use in the shared spectrum. In this situation, W₁ can be weighted to have a value of W₁=1 and W₂ can be weighted to have a value of W₂=1−W₁. Or, if a network element desires a channel that is stable but does not require immediate authorization, the recommendation score can be weighted such that W₂=1 and W₁=1−W₂. As another example, the network element may want a channel that is available for immediate authorization but also one that provides good operation power after CPAS. For this example, the recommendation score can be weighted so that W₂=0.75 and W₁=1−W₂. Other weighting combinations are possible as well. At block 608, the candidate channels are ranked based on the recommendation score assigned to each of the channels.

Proceeding to block 610, method 600 then selects one or more channels and one or more operating parameters for recommendation to the network element. In some embodiments, the SAS selects a channel based on the recommendation score. In one embodiment, the SAS selects a channel with the highest recommendation score. If the highest recommendation score is shared among a plurality of channels, the SAS can select a channel randomly from that group, or send all three channels as a recommendation.

Method 600 selects one or more operating parameters for the channel. The operating parameters can include a frequency (which can be a frequency range bounded by an upper and lower frequency) and a transmit power for the selected channel. The transmit power can be determined based on the transmit power estimate(s) as described above. At block 612, method 600 sends the operating parameters for the selected channel to the network element as recommendation to the network element.

Method 600 can optionally proceed to block 614 to determine whether the channel recommendation evaluated from the channel recommendation process has been accepted by the network element. In one embodiment, the SAS includes an internal clock that sets a timer to a predetermined value, and which decrements in value after a recommendation has been sent to the requesting network element. If the recommendation is not accepted, then method 600 proceeds to block 616 noting that the recommendation is not accepted by network element and the network element cannot access the shared spectrum (at least until a grant request is subsequently approved). The rejection can occur through implicit rejection (e.g., the network element fails to send a new grant request with the conforming parameters that was recommended to the SAS before the internal timer expires), or counter-rejection (e.g., the network element sends a new grant request with non-conforming parameters from the recommended parameters sent by the SAS). The SAS is free to use the channel for recommendation for other network elements if the requesting network element rejects the channel recommendation. In contrast, the network element can accept the recommendation by sending a grant request to the SAS that conforms to the channel recommendation parameters, in which case method 600 proceeds to block 618 by approving the request and authorizing the network element to operate over the channel. In another embodiment, based on the indicated preference of the network element, the recommended channel may not be available for immediate use and the SAS might not authorize the network element to operate over the channel immediately.

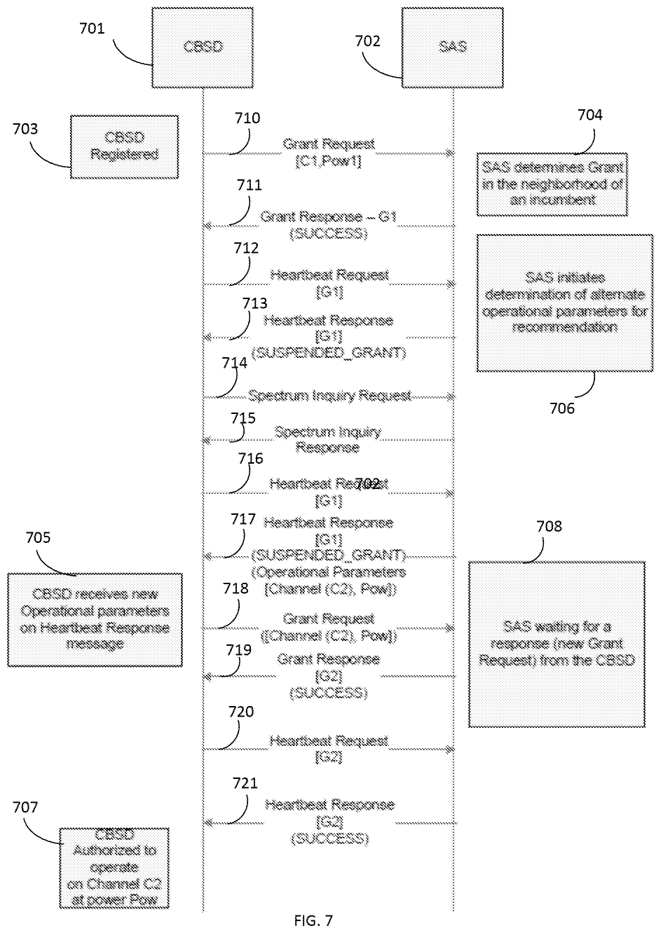

FIG. 7 is a message diagram illustrating communications between an SAS 702 and a CBSD 701 in which an SAS 702 conveys a channel recommendation to the CBSD 701 utilizing, for example, the techniques described in FIG. 6. Once the CBSD 701 is registered (block 703) in the shared spectrum communication system, the CBSD 701 then sends a grant request to the SAS 702 for access to the shared spectrum including a selected channel (C1) and a power level (Pow1) (message 710). The SAS 702 determines whether the grant request lies within the neighborhood (e.g., frequency band) of one or more incumbent users (block 704). If so, then the SAS 702 sends a message back to the CBSD 701 approving the grant request (message 711). The SAS initiates determination of alternate operational parameters for recommendation (block 706). The SAS 702 also receives heartbeat request(s) from the CBSD 701 (message 712) and sends heartbeat response message(s) to the CBSD 701 (message 713) suspending the grant.

The CBSD 701 and SAS 702 can exchange other messages about operating parameters of the spectrum (message 714 and message 715). After determining the recommendation parameters, the SAS 702 conveys on the heartbeat response message (message 717), for a heartbeat request from CBSD 701 (message 716), a channel recommendation to the CBSD 701 including the transmit power requirements (Pow) and a new channel (C2) for CBSD 701 (block 705) and waits for a response from the CBSD 701 in the form of a new grant request (block 708). The CBSD 701 sends a new grant request (G2) in accordance with the channel recommendation (message 718). The SAS 702 sends a grant response message 719 indicating that the new grant request has been approved (SUCCESS) to the CBSD 701. The CBSD 701 and SAS 702 then exchange heartbeat messages 720 and 721 enabling communications over the recommended channel (block 707).

FIG. 8 is a flow diagram of an exemplary method of selecting at least one alternate channel for a network element (such as a CBSD) in response to a notice of a Dynamic Protection Area activation for an incumbent device in a shared spectrum communications network. Method 800 begins when the SAS receives notice of a DPA activation at block 802. At block 804, method 800 proceeds by suspending one or more network elements whose spectrum access overlaps with the scope of the DPA coverage. The SAS can further send a message to the network element informing it of the suspension while it evaluates alternative channels to recommend for the network element. For each affected network element, method 800 then identifies candidate channels of a frequency band at block 805. At block 806, method 800 determines whether there are any incumbent-free channels in the list of candidate channels. If so, then method 800 can proceed directly to block 810 to select one of the incumbent-free channels.

If no incumbent-free channels are available, then at block 809, method 800 begins the channel ranking process to provide a channel recommendation that satisfies the requirements of the DPA coverage zone. At block 807, method 800 initially determines at least one transmit power estimate for each respective channel. In some embodiments, the transmit power estimate is based on a first and second transmit power estimate for the respective channel. Method 800 then scores the candidate channels based the transmit power estimates corresponding to each channel and ranks the channels at block 808 based on the scores. Determining the transmit power estimates, scoring each of the channels, and ranking the channels can be done via the techniques described with respect to FIGS. 5-7.

Once the channels have been evaluated and ranked, method 800 proceeds to block 810 by selecting at least one channel for recommendation along with one or more operating parameters to the affected network elements. Method 800 then proceeds to block 812 by sending the recommended channel and operating parameters to each respective network element suspended by the DPA.

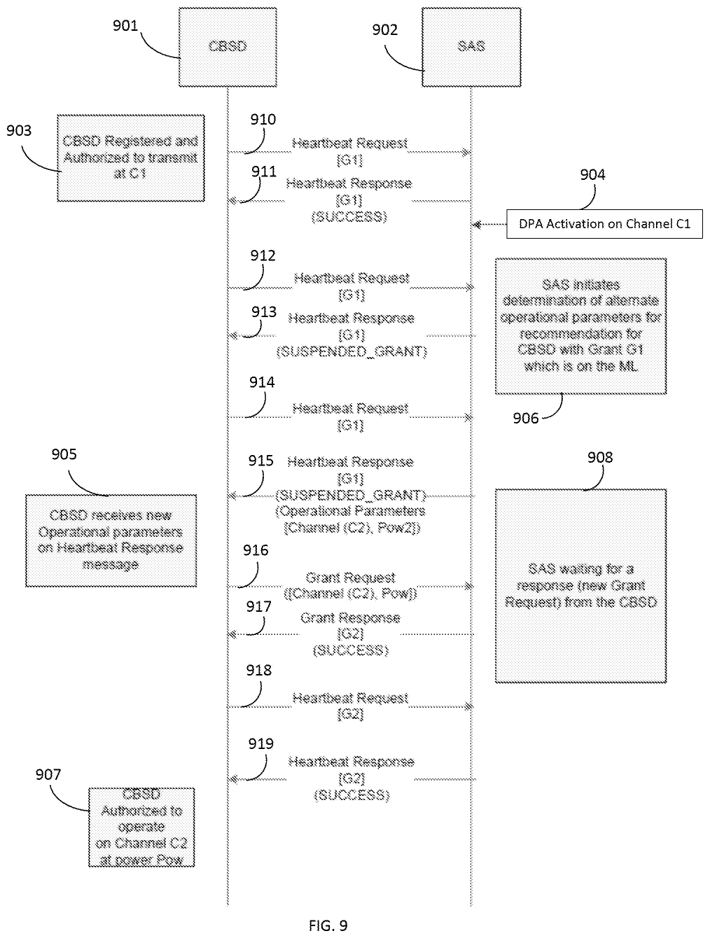

FIG. 9 is a message diagram illustrating communications between an SAS 902 and a CBSD 901 in which an SAS 902 conveys a channel recommendation to the CBSD 901 utilizing, for example, the techniques described in FIG. 8. The example assumes a registered CBSD 901 that has an approved grant G1 and authorized to communicate over channel C1 (block 903). The CBSD is successfully heart-beating with the SAS (message 910 and 911).

At some later point in time, the SAS 902 receives a message indicating that a DPA has been activated for one or more incumbent users in the shared spectrum (block 904), and that channel C1 lies within the scope of the DPA. The shared spectrum block is further sub-divided into individual channels, for example in 10 MHz blocks for DPA activation purposes. For all channels in the shared spectrum, including channel C1, a Move List (ML) is available. The ML is a list for each channel, that specifies which authorized grants should be suspended in response to a DPA activation. Meanwhile, CBSD 901 sends a heartbeat message (message 912) requesting continued access to channel C1 pursuant to the terms of approved grant request G1. Upon receiving notice of a DPA activation, SAS 902 determines that the grant G1 is on the Move List and accordingly sends a heartbeat response message (message 913) to the CBSD suspending access to channel C1. The SAS 902 begins the channel recommendation process to determine an alternative channel for the CBSD 901 (block 906). Periodically, CBSD 901 can send one or more additional heartbeat messages (message 914) requesting access to the shared spectrum pursuant to the terms of previously approved grant request G1. Once the SAS 902 determines a suitable channel, the SAS 902 sends a heartbeat response message (message 915) that is received by the CBSD 901 with the channel recommendation including the operational parameters (C2 and Pow2) (block 905).

After sending the channel recommendation, the SAS 902 waits for a period of time for a response from the CBSD 901 (block 908). When the CBSD 901 approves the channel recommendation, it sends a grant request message (message 916) to the SAS 902 with the channel recommended by the SAS 902 and with the operational parameters given with the channel recommendation. The SAS 902 checks that the new grant request conforms with the channel recommendation parameters and sends a message (message 917) to the CBSD 901 approving the new grant request. After receiving a heartbeat message (message 918) from CBSD 901 requesting access to channel C2 pursuant to grant request G2, SAS 902 then sends a heartbeat message (message 919) to the CBSD 901 enabling the CBSD to access and communicate over the selected channel (C2) with transmit power (Pow2) (block 907).

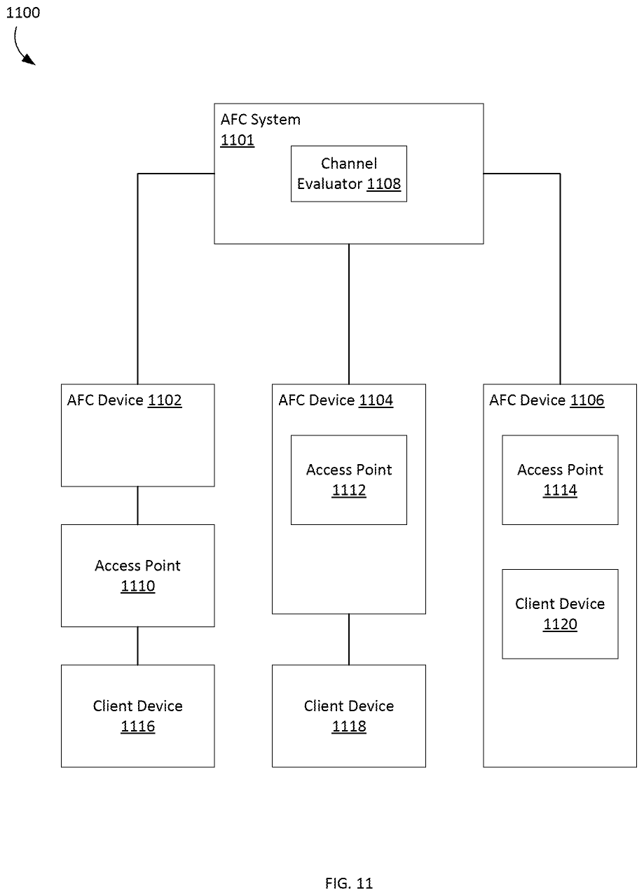

In some embodiments, the shared spectrum communication system 100 is implemented as an automated frequency coordination (AFC) network 1100, as depicted in FIG. 11. In particular, the channel evaluation and recommendation functions as described with respect to FIGS. 1-10 also apply to the AFC network 1100 as described further herein. Referring to FIG. 11, AFC system 1101 functions similarly to SAS 100 and includes a channel evaluator 1108 configured to evaluate channels in a frequency band of a shared spectrum using the techniques described in FIGS. 1-10. When AFC system 1101 receives a request for spectrum access from a network element in the AFC network 1100, AFC system 1101 evaluates channels based on a plurality of criteria (as described in FIG. 5 and as further described herein) and communicates the evaluated channel list to the network element.

In the embodiment shown in FIG. 11, AFC system 100 is communicatively coupled to a plurality of AFC devices, three of which are pedagogically illustrated as AFC device 1102, AFC device 1104, and AFC device 1106. The AFC devices can be remotely located from the AFC system 100 and remotely located from each other in different geographical locations covered by the AFC network 1100. The AFC system 100 transmits and receives signals from the coupled AFC devices through an appropriate interface.

Each AFC device is configured to send an inquiry to the AFC system 1101 for access to the shared spectrum. As previously described, the inquiry in some embodiments includes additional parameters about the particular AFC device such as the intended transmit power the device intends to use in transmitting over the requested channel in the AFC network 1100, the geographical location of the device, or other operating parameters that the device requires to utilize the shared spectrum. Additionally, the AFC devices are configured to request information from AFC system 1101 about parameters of the shared spectrum, such as which channels are available (if any), the desired transmit power for a channel, and other frequency spectrum information. The AFC system 1101 responds to the inquiry request with a message that includes the requested parameters. Alternatively, the AFC system 1101 is configured to determine frequency spectrum information of the shared spectrum when the AFC device registers with the AFC system 1101.

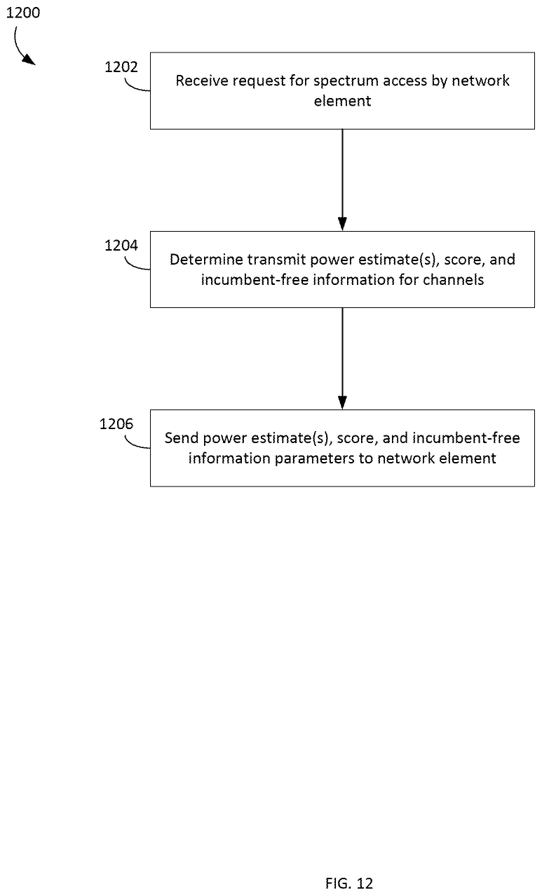

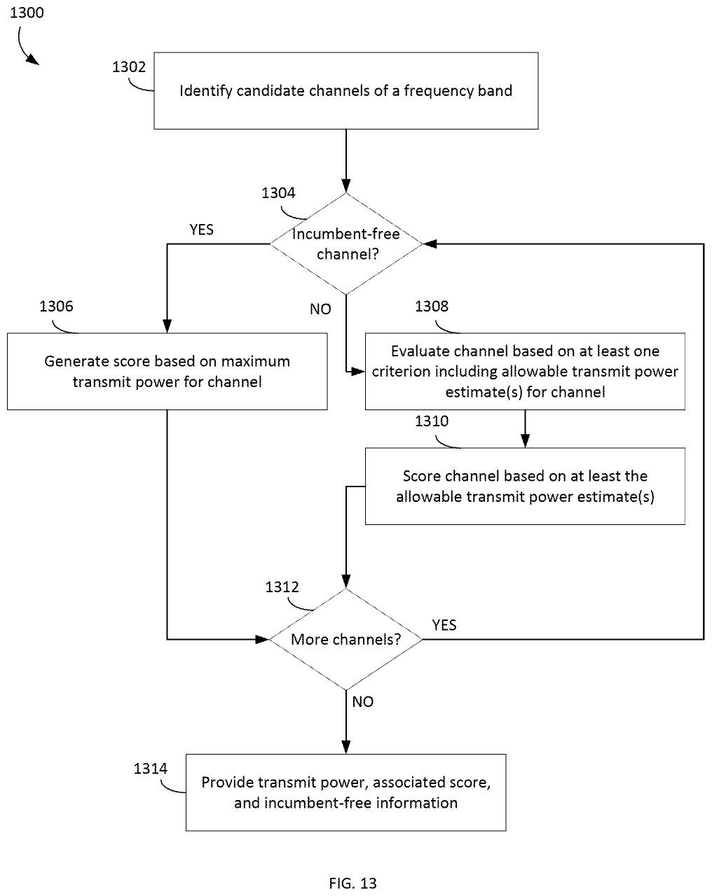

When an AFC device (for example, AFC device 1102) sends an inquiry request to AFC system 1101, AFC system 1101 is configured to initiate a channel evaluation process to evaluate a plurality of candidate channels of the shared spectrum based on at least one criterion, as further described in FIGS. 12-13 or in conjunction with the channel recommendation processes previously described in FIGS. 1-10. Specifically, AFC system 1101 includes a channel evaluator 1108 configured to evaluate the plurality of candidate channels and to generate an output which, in some embodiments, includes a list of candidate channels that have been scored based on the evaluation of the one or more criteria applied to each candidate channel. Once the channels have been evaluated, AFC system 1101 is configured to send a message to AFC device 1102 that includes the evaluated channels. In one embodiment, AFC system 1101 includes the evaluated channels in a field (e.g., the vendorExtensions field) of the inquiry response message generated in response to AFC device 1102 requesting information on parameters of the shared spectrum.

For AFC network 1100, the AFC devices are configured to request spectrum access for a respective client device serviced by the AFC device. For example, in FIG. 11, AFC device 1102 is configured to request a channel for client device 1116. AFC device 1102 and client device 1116 are communicatively coupled to each other via access point 1110. Although not explicitly shown, an AFC device can be coupled to more than one client device. Alternatively, the AFC device may include an access point, such as AFC device 1104. This enables AFC device 1104 to communicate directly to its respective client device 1118 over access point 1112. For example, when AFC device 1104 receives an evaluated channel list from AFC system 1101, it is configured to determine a channel of operation for the client device 1118 based on the channel evaluation provided by AFC system 1101. The AFC device 1104 communicates with its respective client devices 1118 using a conventional communication protocol, such as the WiFi 802.11 protocol.

Alternatively, the AFC device 1106 includes the functionality of the client device (and corresponding access point 1114), as shown with respect to AFC device 1106. In this case, AFC device 1106 is configured to determine a channel based on the channel evaluation of candidate channels sent by AFC system 1101. When the AFC device 1106 determines the channel to use, it then operates in the selected channel in accordance with the parameters given by the AFC system 1101.

In one embodiment, the spectrum access system (the AFC system 1101, for example) can determine and send a channel evaluation list to a network element as illustrated in FIG. 12. FIG. 12 depicts an exemplary method 1200 for evaluating channels including one or more parameters of an incumbent-free channel. Method 1200 may be implemented via the techniques described with respect to FIGS. 1-11, but may be implemented via other techniques as well. The blocks of the flow diagram have been arranged in a generally sequential manner for ease of explanation; however, it is to be understood that this arrangement is merely exemplary, and it should be recognized that the processing associated with the methods described herein (and the blocks shown in the Figures) may occur in a different order (for example, where at least some of the processing associated with the blocks is performed in parallel and/or in an event-driven manner).

According to block 1202, method 1200 receives a request for spectrum access by a network element. In the AFC model, the request is sent by an AFC device and corresponds to one or more client devices coupled to the AFC device (or alternatively is part of the AFC device if the AFC device also acts as a client device). At block 1204, method 1200 proceeds by evaluating channels of a frequency band based on at least one criterion of the shared spectrum communication network. The AFC model comprises a frequency band of 6 GHz that can be partitioned into multiple channels (for example, as described with respect to FIGS. 10A-10B). Accordingly, in one embodiment, method 1200 evaluates channels of a 6 GHz frequency band based on at least one criterion.

In some embodiments, the at least one criterion includes an evaluation of whether the candidate channel impacts one or more incumbents in the shared spectrum communication network. This criterion is particularly important for the client devices since these network elements could be located in a geographical location where it may experience interference or spectrum access revocation due to the protections afforded to incumbent users. Therefore, incumbent-free channels will, in some embodiments, will have the highest priority for the client device since selecting an incumbent-free channel minimizes the risk of future interference due to incumbent activity. In the AFC model, incumbent users include microwave fixed stations located in a geographical location covered by the shared spectrum communication system. Information about known incumbent users in the AFC network 1100 can be retrieved by AFC system 1101 from a database (not shown in FIG. 11).

Still referring to FIG. 12, method 1200 at block 1204 scores the evaluated channels based on the at least one criterion, including the incumbent-free information, the at least one transmit power estimate(s), and other criteria for the network element. For example, method 1200 optionally ranks the scored channels and generates a list of evaluated channels that is organized based on the ranks associated with each channel. In this embodiment, a channel with a higher ranking (such as an incumbent-free channel with suitable transmit power estimate(s)) will be associated with a higher ranking than an incumbent-impacting channel. One exemplary embodiment for performing block 1204 is further described with respect to FIG. 13.

Method 1200 proceeds to block 1206 and sends the evaluated channels to the network element. For example, method 1200 sends information about the plurality of candidate channels including information on the transmitted power estimate(s) for the candidate channels, the incumbent-free information for the candidate channels, and the scores given to each candidate channel to the network element. The network element can then use the evaluated channel information to select a channel to request for access to the shared spectrum.

FIG. 13 depicts one exemplary embodiment of a method 1300 for determining one or more parameters for channels of a plurality of candidate channels, which in an embodiment is performed based on block 1204 of method 1200. However, method 1300 may be performed in conjunction with the other techniques for evaluating and recommending channels as previously described with respect to FIGS. 1-10A-10B.

Beginning at block 1302, method 1300 identifies a plurality of candidate channels of a frequency band. In one embodiment, candidate channels are identified based on channel or frequency spectrum information that is received from the network element. In other embodiments, channel or frequency spectrum information is obtained for the frequency band when the network element registers with the spectrum access system. Method 1300 then proceeds to block 1304 and determines, for each candidate channel, whether that candidate channel is an incumbent-free channel. If a given candidate channel is an incumbent-free channel, the channel is designated with an indicator that marks the candidate channel as an incumbent-free channel. If a given candidate channel is not incumbent-free channel (an incumbent-impacting channel, for example), a different indicator (or alternatively, no indicator) is used to mark the candidate channel as a non-incumbent-free channel.

An incumbent-free channel is evaluated differently than a non-incumbent-free channel. As shown in FIG. 13, method 1300 proceeds to block 1306 to generate a score for the incumbent-free candidate channel based on a maximum transmit power estimate for that channel. At this stage, an incumbent-free candidate channel with a large maximum transmit power estimate will be given a higher score since this means a client device utilizing this channel will not impact known incumbent activity and will have a high maximum transmit power requirement while utilizing the channel. From block 1306, method 1300 proceeds to block 1312 and determines whether there are any additional candidate channels that need to be evaluated.

A channel that is not incumbent-free as determined at block 1304 is evaluated as indicated at block 1308. Here method 1300 evaluates the non-incumbent-free channel based on at least one criterion including at least one allowable transmit power estimate for that channel. The allowable transmit power estimate(s) can be determined based on the transmit power estimation techniques previously described. Method 1300 then proceeds to block 1310 and scores the non-incumbent-free channel based on the at least one allowable transmit power estimates and optionally other criteria used to evaluate the candidate channels. For example, a non-incumbent-free channel with a higher allowable transmit power estimate will be given a higher score than a non-incumbent-free channel with a lower allowable transmit power estimate. However, in most cases a non-incumbent-free channel will be given a lower score than an incumbent-free channel even if the allowable transmit power for the non-incumbent-free channel is comparable to a maximum transmit power determined for the incumbent-free channel, since a non-incumbent-free channel risks future impact to known incumbent users and hence risks future spectrum access interference to the network element if this channel is used.

At block 1312, method 1300 determines whether there are additional channels that need to be evaluated. If so, method 1300 reverts back to block 1304 to determine first whether the next channel to be evaluated is an incumbent-free channel, and then proceeds to evaluate and score the next channel accordingly as previously described. If all the candidate channels have been evaluated, method 1300 proceeds to block 1314 and provides the transmit power estimates, the incumbent-free information, and the associated scores for each of the plurality of candidate channels to the network element.

One skilled in the art upon reading this disclosure will understand that the methods and flow charts described above do not necessarily correspond to exclusive embodiments and that aspects described with respect to one method or flow chart can also apply to aspects of another method or flow chart. For example, embodiments described with respect to method 500 can apply to method 600 or method 800 and vise-versa. The methods and figures described above therefore should not be interpreted as limiting the disclosure but rather to illustrate embodiments of the invention in an exemplary context.

The terms “about”, “approximately”, or “substantially” mean that the value or parameter specified may be somewhat altered, as long as the alteration does not result in nonconformance of the process or structure to the illustrated embodiment from the perspective of one having ordinary skill in the art. The term “exemplary” merely indicates the accompanying description is used as an example, rather than implying an ideal, essential, or preferable feature of the invention.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forma of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed ASICs.

### Example Embodiments

Example 1 includes a method for selecting a channel for a network element in a shared spectrum communication system, the method comprising: identifying a plurality of candidate channels of a frequency band of the shared spectrum communication system; for each of the plurality of candidate channels, determining at least one transmit power estimate based on at least one available interference margin, wherein the at least one available interference margin is based on a power allocation protocol for the shared spectrum communication system; scoring each of the plurality of candidate channels based on at least the at least one transmit power estimate; ranking the plurality of candidate channels based on the scores for each of the plurality of candidate channels; and selecting one of the plurality of candidate channels based on the ranking of the plurality of candidate channels.

Example 2 includes the method of Example 1, wherein the at least one available interference margin comprises a plurality of available interference margins, wherein each available interference margin is based on a distinct power allocation protocol for the shared spectrum communication system.

Example 3 includes the method of any of Examples 1-2, wherein selecting the one of the plurality of candidate channels includes selecting one or more operating parameters for the one of the plurality of candidate channels including a frequency range defined by an upper frequency and a lower frequency, and a transmit power.

Example 4 includes the method of any of Examples 1-3, comprising determining the at least one transmit power estimate by: determining a first transmit power estimate based on a first available interference margin of the at least one available interference margin; and determining a second transmit power estimate based on a second available interference margin of the at least one available interference margin.

Example 5 includes the method of Example 4, wherein determining a first transmit power estimate and a second transmit power estimate comprise determining a transmit power estimate calculated outside of a Coordinated Activities Among SASs (CPAS) window and determining a transmit power estimate during the CPAS window, respectively.

Example 6 includes the method of any of Examples 4-5, wherein scoring each of the plurality of candidate channels comprises computing a recommendation score for each of the plurality of candidate channels, wherein the recommendation score is based on a sum of the first transmit power estimate and the second transmit power estimate.

Example 7 includes the method of any of Examples 4-6, wherein scoring each of the plurality of candidate channels comprises weighting the first transmit power estimate and the second transmit power estimate based on one or more parameters received from the network element.

Example 8 includes the method of any of Examples 4-7, further comprising determining the first power transmit estimate based on an operational transmit power threshold for the network element and an authorized power change metric.

Example 9 includes the method of any of Examples 3-8, further comprising sending a message to the network element including the selected one of the plurality of candidate channels and the one or more operating parameters.

Example 10 includes the method of any of Examples 1-9, wherein determining the at least one transmit power estimate further comprises: constraining the at least one transmit power estimate corresponding to a respective candidate channel of the plurality of candidate channels based on adverse impact to other network elements in the shared spectrum communication system communicating at or near the respective candidate channel; and wherein scoring the each of the plurality of candidate channels further comprises scoring the respective candidate channel based on whether the at least one transmit power estimate exceeds an operational transmit power threshold.

Example 11 includes a channel evaluator, comprising: a communication interface; a storage media storing a channel recommendation function; and at least one processor coupled to the communication interface and the storage media, wherein the at least one processor is configured to execute the channel recommendation function to evaluate channels for a network element of a shared spectrum communication system by: identifying a plurality of candidate channels of a frequency band of the shared spectrum communication system; for each of the plurality of candidate channels, determining at least one transmit power estimate based on at least one available interference margin, wherein each available interference margin is based on a power allocation protocol for the shared spectrum communication system; scoring each of the plurality of candidate channels based on at least the at least one transmit power estimate; ranking the plurality of candidate channels based on the scores for each of the plurality of candidate channels; and selecting one of the plurality of candidate channels based on the ranking of the plurality of candidate channels.

Example 12 includes the channel evaluator of Example 11, wherein the channel recommendation function, running on the at least one processor, is configured to evaluate channels by: determining whether the frequency band includes one or more incumbent users to be protected; identifying a plurality of candidate channels of a frequency band of the shared spectrum communication system when the frequency band includes one or more incumbent users to be protected; and enabling communications for the network element based on a received grant request from the network element when the frequency band does not include one or more incumbent users to be protected.

Example 13 includes the channel evaluator of any of Examples 11-12, wherein the channel recommendation function, running on the at least one processor, is further configured to: send a message including the selected candidate channel to the network element; determine whether the network element has accepted the selected candidate channel; enable communications for the network element on the selected candidate channel when the network element has accepted the selected candidate channel.

Example 14 includes the channel evaluator of Example 13, wherein to determine whether the network element has accepted the selected candidate channel comprises: setting a timer to a value; decrementing the timer in response to sending the message including the selected candidate channel; and determining that the network element has not accepted the selected candidate channel when the timer decrements to a value of zero.

Example 15 includes the channel evaluator of any of Examples 11-14, wherein the channel recommendation function, running on the at least one processor, is configured to evaluate channels by identifying a plurality of candidate channels of a frequency band further comprises: determining whether a potential channel is overlapping with a frequency of one or more incumbent users in the frequency band; designating the potential channel as an incumbent-impacting channel when the potential channel is overlapping with a frequency of one or more incumbent users; and designating the potential channel as an incumbent-free channel when the potential channel is non-overlapping with a frequency of one or more incumbent users.

Example 16 includes the channel evaluator of any of Examples 11-15, wherein the channel recommendation function, running on the at least one processor is configured to evaluate channels by identifying a plurality of candidate channels of a frequency band further comprises: partitioning the frequency band into a first set of channels, wherein each channel in the first set of channels is non-overlapping in frequency; and partitioning the frequency band into a second set of channels, wherein at least one channel in the second set of channels is overlapping in frequency with respect to at least one channel in the first set of channels.

Example 17 includes the channel evaluator of any of Examples 15-16, wherein selecting a candidate channel comprises selecting one of the designated incumbent-free channels.

Example 18 includes the channel evaluator of any of Examples 15-17, wherein scoring each of the candidate channels comprises scoring each designated incumbent-impacting channel when no incumbent-free channels are available; and wherein selecting a candidate channel comprises selecting an incumbent-impacting channel.

Example 19 includes a method for selecting an alternate channel for a network element in a shared spectrum communication system, comprising: receiving a grant request from the network element for a channel in the shared spectrum communication system; determining that the grant request includes a frequency that is overlapping with a frequency of one or more incumbent users in the shared spectrum communication system; selecting an alternative channel to provide to the network element by: identifying a plurality of candidate channels of a frequency band of the shared spectrum communication system; for each of the plurality of candidate channels, determining at least one transmit power estimate based on at least one available interference margin, wherein the at least one available interference margin is based on a power allocation protocol for the shared spectrum communication system; scoring each of the plurality of candidate channels based on at least the at least one transmit power estimate; ranking the plurality of candidate channels based on the scores for each of the plurality of candidate channels; and selecting one of the plurality of candidate channels based on the ranking of the plurality of candidate channels.

Example 20 includes the method of Example 19, wherein the at least one available interference margin comprises a plurality of available interference margins, wherein each available interference margin is based on a distinct power allocation protocol for the shared spectrum communication system.

Example 21 includes the method of any of Examples 19-20, wherein selecting the one of the plurality of candidate channels includes selecting one or more operating parameters for the one of the plurality of candidate channels including a frequency range defined by an upper frequency and a lower frequency, and a transmit power.

Example 22 includes the method of any of Examples 19-21, comprising determining the at least one transmit power estimate by: determining a first transmit power estimate based on a first available interference margin of the at least one available interference margin; and determining a second transmit power estimate based on a second available interference margin of the at least one available interference margin.

Example 23 includes the method of Example 22, wherein scoring each of the plurality of candidate channels comprises computing a recommendation score for each of the plurality of candidate channels, wherein the recommendation score is based on a sum of the first transmit power estimate and the second transmit power estimate.

Example 24 includes the method of any of Examples 22-23, wherein scoring each of the plurality of candidate channels comprises weighting the first transmit power estimate and the second transmit power estimate based on one or more parameters received from the network element.

Example 25 includes a method for selecting an alternate channel for a network element in a shared spectrum communication system, comprising: receiving notice of a Dynamic Protection Area (DPA) activation that covers one or more frequencies in the shared spectrum communication system utilized by the network element; suspending access to the shared spectrum communication system for the network element; and selecting at least one alternative channel to send to the network element by: identifying a plurality of candidate channels of a frequency band of the shared spectrum communication system; for each of the plurality of candidate channels, determining at least one transmit power estimate based on at least one available interference margin, wherein each available interference margin is based on a power allocation protocol for the shared spectrum communication system; scoring each of the plurality of candidate channels based on at least the at least one transmit power estimate; ranking the plurality of candidate channels based on the scores for each of the plurality of candidate channels; and selecting one of the plurality of candidate channels based on the ranking of the plurality of channels.

Example 26 includes the method of Example 25, wherein the at least one available interference margin comprises a plurality of available interference margins, wherein each available interference margin is based on a distinct power allocation protocol for the shared spectrum communication system.

Example 27 includes the method of any of Examples 25-26, wherein selecting the one of the plurality of candidate channels includes selecting one or more operating parameters for the one of the plurality of candidate channels including a frequency range defined by an upper frequency and a lower frequency, and a transmit power.

Example 28 includes the method of any of Examples 25-27, comprising determining the at least one transmit power estimate by: determining a first transmit power estimate based on a first available interference margin of the at least one available interference margin; and determining a second transmit power estimate based on a second available interference margin of the at least one available interference margin.

Example 29 includes the method of Example 28, further comprising determining the first power transmit estimate based on an operational transmit power threshold for the network element and an authorized power change metric.

Example 30 includes the method of Example 29, wherein identifying a plurality of candidate channels comprises designating a potential channel as a candidate channel when the first transmit power estimate exceeds the operation transmit power threshold and the authorized power change metric exceeds an authorized power change threshold for the potential channel.

Example 31 includes a method, comprising identifying a plurality of candidate channels of a frequency band of a shared spectrum; for each candidate channel of the plurality of channels, determining whether the candidate channel is an incumbent-free channel; when the candidate channel is determined to be an incumbent-free channel: scoring the candidate channel based on a maximum transmit power estimate for the candidate channel; when the candidate channel is determined to not be an incumbent-free channel: evaluating the candidate channel based on at least one criterion of the shared spectrum, wherein the at least one criterion includes at least one allowable transmit power estimate for the candidate channel based on at least one available interference margin, wherein the at least one available interference margin is based on a power allocation protocol for the shared spectrum communication system; scoring the candidate channel based on at least the at least one allowable transmit power estimate; and providing the scores for each candidate channel of the plurality of channels to a network element of a shared spectrum communication system.

Example 32 includes the method of Example 31, wherein providing the scores for each candidate channel comprises sending a message including a list of the scored candidate channels to an automated frequency coordination (AFC) device.

Example 33 includes the method of any of Examples 31-32, wherein scoring the candidate channel comprises assigning a first score to the candidate channel when the candidate channel is determined to be an incumbent-free channel; and assigning a second score to the candidate channel when the candidate channel is determined to not be an incumbent-free channel, wherein the first score is higher than the second score.

Example 34 includes the method of any of Examples 31-33, comprising determining one or more parameters of the shared spectrum in response to a request by the network element.

Example 35 includes a channel evaluator, comprising: a communication interface; a storage media storing a channel evaluation function; and at least one processor coupled to the communication interface and the storage media, wherein the at least one processor is configured to execute the channel evaluation function to evaluate channels for a network element of a shared spectrum communication system by: identifying a plurality of candidate channels of a frequency band of a shared spectrum; for each candidate channel of the plurality of channels, determining whether the candidate channel is an incumbent-free channel; when the candidate channel is determined to be an incumbent-free channel: scoring the candidate channel based on a maximum transmit power estimate for the candidate channel; when the candidate channel is determined to not be an incumbent-free channel: evaluating the candidate channel based on at least one criterion of the shared spectrum, wherein the at least one criterion includes at least one allowable transmit power estimate for the candidate channel based on at least one available interference margin, wherein the at least one available interference margin is based on a power allocation protocol for the shared spectrum communication system; and scoring the candidate channel based on at least the at least one allowable transmit power estimate; wherein the at least one processor is configured to generate a list that includes the scored candidate channels.

Example 36 includes the channel evaluator of Example 35, wherein the at least one processor is configured to assign a first score to the candidate channel when the candidate channel is determined to be an incumbent-free channel; and is configured to assign a second score to the candidate channel when the candidate channel is determined to not be an incumbent-free channel, wherein the first score is higher than the second score.

Example 37 includes the channel evaluator of any of Examples 35-36, wherein the at least one processor is configured to determine one or more parameters of the shared spectrum in response to a request by the network element.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A method for selecting a channel for a network element in a shared spectrum communication system, the method comprising:
identifying a plurality of candidate channels of a frequency band of the shared spectrum communication system;
for each of the plurality of candidate channels, determining at least one transmit power estimate based on at least one available interference margin, wherein the at least one available interference margin is based on a power allocation protocol for the shared spectrum communication system;
scoring each of the plurality of candidate channels based on at least the at least one transmit power estimate;
ranking the plurality of candidate channels based on the scores for each of the plurality of candidate channels; and
selecting one of the plurality of candidate channels based on the ranking of the plurality of candidate channels.

2. The method of claim 1, wherein the at least one available interference margin comprises a plurality of available interference margins, wherein each available interference margin is based on a distinct power allocation protocol for the shared spectrum communication system.

3. The method of claim 1, wherein selecting the one of the plurality of candidate channels includes selecting one or more operating parameters for the one of the plurality of candidate channels including a frequency range defined by an upper frequency and a lower frequency, and a transmit power.

4-8. (canceled)

9. The method of claim 3, further comprising sending a message to the network element including the selected one of the plurality of candidate channels and the one or more operating parameters.

10. The method of claim 1, wherein determining the at least one transmit power estimate further comprises:
constraining the at least one transmit power estimate corresponding to a respective candidate channel of the plurality of candidate channels based on adverse impact to other network elements in the shared spectrum communication system communicating at or near the respective candidate channel;
and wherein scoring the each of the plurality of candidate channels further comprises scoring the respective candidate channel based on whether the at least one transmit power estimate exceeds an operational transmit power threshold.

11. A channel evaluator, comprising:
a communication interface;
a storage media storing a channel recommendation function; and
at least one processor coupled to the communication interface and the storage media, wherein the at least one processor is configured to execute the channel recommendation function to evaluate channels for a network element of a shared spectrum communication system by:
identifying a plurality of candidate channels of a frequency band of the shared spectrum communication system;
for each of the plurality of candidate channels, determining at least one transmit power estimate based on at least one available interference margin, wherein each available interference margin is based on a power allocation protocol for the shared spectrum communication system;
scoring each of the plurality of candidate channels based on at least the at least one transmit power estimate;
ranking the plurality of candidate channels based on the scores for each of the plurality of candidate channels; and
selecting one of the plurality of candidate channels based on the ranking of the plurality of candidate channels.

12. The channel evaluator of claim 11, wherein the channel recommendation function, running on the at least one processor, is configured to evaluate channels by:
determining whether the frequency band includes one or more incumbent users to be protected;
identifying a plurality of candidate channels of a frequency band of the shared spectrum communication system when the frequency band includes one or more incumbent users to be protected; and
enabling communications for the network element based on a received grant request from the network element when the frequency band does not include one or more incumbent users to be protected.

13. The channel evaluator of claim 11, wherein the channel recommendation function, running on the at least one processor, is further configured to:
send a message including the selected candidate channel to the network element;
determine whether the network element has accepted the selected candidate channel;
enable communications for the network element on the selected candidate channel when the network element has accepted the selected candidate channel.

14. The channel evaluator of claim 13, wherein to determine whether the network element has accepted the selected candidate channel comprises:
setting a timer to a value;
decrementing the timer in response to sending the message including the selected candidate channel; and
determining that the network element has not accepted the selected candidate channel when the timer decrements to a value of zero.

15. The channel evaluator of claim 11, wherein the channel recommendation function, running on the at least one processor, is configured to evaluate channels by identifying a plurality of candidate channels of a frequency band further comprises:
determining whether a potential channel is overlapping with a frequency of one or more incumbent users in the frequency band;
designating the potential channel as an incumbent-impacting channel when the potential channel is overlapping with a frequency of one or more incumbent users; and
designating the potential channel as an incumbent-free channel when the potential channel is non-overlapping with a frequency of one or more incumbent users.

16. The channel evaluator of claim 11, wherein the channel recommendation function, running on the at least one processor is configured to evaluate channels by identifying a plurality of candidate channels of a frequency band further comprises:
partitioning the frequency band into a first set of channels, wherein each channel in the first set of channels is non-overlapping in frequency; and
partitioning the frequency band into a second set of channels, wherein at least one channel in the second set of channels is overlapping in frequency with respect to at least one channel in the first set of channels.

17. The channel evaluator of claim 15, wherein selecting a candidate channel comprises selecting one of the designated incumbent-free channels.

18. The channel evaluator of claim 15, wherein scoring each of the candidate channels comprises scoring each designated incumbent-impacting channel when no incumbent-free channels are available; and wherein selecting a candidate channel comprises selecting an incumbent-impacting channel.

19-24. (canceled)

25. A method for selecting an alternate channel for a network element in a shared spectrum communication system, comprising:
receiving notice of a Dynamic Protection Area (DPA) activation that covers one or more frequencies in the shared spectrum communication system utilized by the network element;
suspending access to the shared spectrum communication system for the network element; and
selecting at least one alternative channel to send to the network element by:
identifying a plurality of candidate channels of a frequency band of the shared spectrum communication system;
for each of the plurality of candidate channels, determining at least one transmit power estimate based on at least one available interference margin, wherein each available interference margin is based on a power allocation protocol for the shared spectrum communication system;
scoring each of the plurality of candidate channels based on at least the at least one transmit power estimate;
ranking the plurality of candidate channels based on the scores for each of the plurality of candidate channels; and
selecting one of the plurality of candidate channels based on the ranking of the plurality of channels.

26-27. (canceled)

28. The method of claim 25, comprising determining the at least one transmit power estimate by:
determining a first transmit power estimate based on a first available interference margin of the at least one available interference margin; and
determining a second transmit power estimate based on a second available interference margin of the at least one available interference margin.

29. The method of claim 28, further comprising determining the first power transmit estimate based on an operational transmit power threshold for the network element and an authorized power change metric.

30. The method of claim 29, wherein identifying a plurality of candidate channels comprises designating a potential channel as a candidate channel when the first transmit power estimate exceeds the operation transmit power threshold and the authorized power change metric exceeds an authorized power change threshold for the potential channel.

31. A method, comprising:
identifying a plurality of candidate channels of a frequency band of a shared spectrum;
for each candidate channel of the plurality of channels, determining whether the candidate channel is an incumbent-free channel;
when the candidate channel is determined to be an incumbent-free channel:
scoring the candidate channel based on a maximum transmit power estimate for the candidate channel;
when the candidate channel is determined to not be an incumbent-free channel:
evaluating the candidate channel based on at least one criterion of the shared spectrum, wherein the at least one criterion includes at least one allowable transmit power estimate for the candidate channel based on at least one available interference margin, wherein the at least one available interference margin is based on a power allocation protocol for a shared spectrum communication system;
scoring the candidate channel based on at least the at least one allowable transmit power estimate; and
providing the scores for each candidate channel of the plurality of channels to a network element of the shared spectrum communication system.

32. The method of claim 31, wherein providing the scores for each candidate channel comprises sending a message including a list of the scored candidate channels to an automated frequency coordination (AFC) device.

33. The method of claim 31, wherein scoring the candidate channel comprises assigning a first score to the candidate channel when the candidate channel is determined to be an incumbent-free channel; and assigning a second score to the candidate channel when the candidate channel is determined to not be an incumbent-free channel, wherein the first score is higher than the second score.

34-37. (canceled)
